(19) United States
(12) Patent Application Publication
(10) Pub. No.: US 2021/0169104 A1
(43) Pub. Date: Jun. 10, 2021

(54) ORAL REHYDRATION COMPOSITION

(71) Applicant: SIX SIGMA LABORATORIES LLC, Louisville, KY (US)

(72) Inventors: Manoj Bhanushali, New Albany, IN (US); Samuel S. Lee, Louisville, KY (US)

(21) Appl. No.: 17/111,161

(22) Filed: Dec. 3, 2020

Related U.S. Application Data
(62) Division of application No. 14/823,598, filed on Aug. 11, 2015, now abandoned.
(60) Provisional application No. 61/999,974, filed on Aug. 11, 2014.
(60) Provisional application No. 62/123,273, filed on Nov. 12, 2014.
(60) Provisional application No. 62/123,919, filed on Dec. 2, 2014.

(51) Int. Cl. A23L 2/39; A23L 2/60; A23L 2/56; A23L 2/68

(52) U.S. Cl. CPC A23L 2/39; A23L 2/60; A23V 2002/00; A23L 2/68; A23L 2/56

(57) ABSTRACT

The presently-disclosed subject matter includes oral rehydration compositions. The presently-disclosed compositions effectively mask the salty taste of the composition without compromising the approximately equimolar concentration of sodium and glucose prescribed by the World Health Organization Oral Rehydration Salt therapies by using a licorice based flavor enhancer in an the optimized formulation. Further disclosed are methods of treatment using the oral rehydration compositions.

### RELATED APPLICATIONS

This application is a Divisional application of U.S. application Ser. No. 14/823,598, having a filing date of Aug. 11, 2015, which claims priority from U.S. Provisional Application Ser. No. 61/999,974 filed Aug. 11, 2014, U.S. Provisional Application Ser. No. 62/123,273 filed Nov. 12, 2014, and U.S. Provisional Application Ser. No. 62/123,919 filed Dec. 2, 2014, the entire disclosures of which are incorporated herein by this reference.

### TECHNICAL FIELD

The presently-disclosed subject matter relates to oral hydration compositions. In particular, the presently-disclosed subject matter relates to oral rehydration compositions and methods of use.

### BACKGROUND

After extensive research and development, the World Health Organization developed a formula containing equimolar concentrations of glucose and sodium, that is, one mole of glucose for every one mole of sodium. The basis for development of the Oral Rehydration Solution (ORS) formula was the discovery of the sodium-glucose co-transport mechanism in the human intestine. Through the sodium-glucose co-transport protein found in the intestinal mucosa of the small intestine, one mole of glucose facilitates the absorption of one mole of sodium. Maintaining the equimolar concentrations of glucose and sodium renders the ORS very salty in taste. Sodium is a critical electrolyte which helps maintain the hydration levels in all bodily tissues. And, to avoid the fluid loss due to osmotic effect, the Osmolarity of the ORS should be comparable to that of plasma.

Naturally-occurring carbohydrate sweeteners, such as sucrose, are the most widely used sweeteners, but they have the disadvantage of high cost and high caloric content. Carbohydrates also increase the osmolarity of the ORS and therefore decrease the rate and quality of rehydration. Artificial sweeteners are another option, yet they are sometimes rejected by the consumer for not having a sufficiently “sucrose-like” taste. Artificial sweeteners have different sweetness profiles from that of sucrose and often exhibit side effects such as delays in the onset of sweetness perception and/or unpleasant aftertastes. Compounds referred to as sweetness modifiers or potentiators can be combined with a sweetener to modify the taste of the sweetener by enhancing or inhibiting the perception of the sweetness of the sweetener or affecting the sweetness profile in some way. Potentiators, flavor enhancers, or high intensity sweeteners provide flavor enhancement and contribute to taste, aroma and feeling factors, and may suppress other flavors creating a synergy with another substance that enhance sweetness. Yet, despite the availability of such potentiators, flavor enhancers, and high intensity sweeteners, identifying a formulation that includes necessary components for optimal rehydration and provides an acceptable taste continues to be a challenge.

Indeed, the problem with masking the salty taste has been a problem for rehydration and beverage companies for years. Popular conventional rehydration beverages and low calorie “sport drinks” contain much more glucose than sodium in order to mask the taste of the electrolytes or “salt” in the beverage. Numerous references suggest new sweeteners are the solution. At least eight high intensity sweeteners have been approved by the Food and Drug Administration due to manufacturers in the beverage industry trying to find a sweetener that did not exhibit an unpleasant after taste or which would duplicate the taste sensation of natural sweeteners such as corn syrup, or sugar derivatives.

Canadian Patent No. 1208966 teaches several aromatic compounds which are claimed as sweetness modifiers. European Patent No. 0132444 and U.S. Pat. No. 4,627,987 describe 3-hydroxybenzoic acid (3-HB) as a sweetness potentiator in combination with sucrose, aspartame and saccharin to enhance sweetness when employed at pH 2.0 to 5.5.

U.S. Pat. No. 6,368,651 teaches the use of mono-ammonium glycyrrhizinate as an ingredient useful as a neotame taste modifying ingredient at a concentration of 0.25 ppm. U.S. Pat. No. 6,391,886, is directed to the use of a combination of coolant and sweetener in oral compositions containing therapeutic agents, and teaches use of monoammonium glycyrrhizinate as a secondary sweetener in an amount of from 0.0001 to about 0.30% by weight. U.S. Pat. No. 7,026,298 teaches an oral rehydration composition with zinc for treatment of diarrhea. U.S. Pat. Nos. 7,851,006 and 8,455,033 and 7,879,376 teach the combination of 3-hydroxybenzoic acid and 3,4 dihydroxybenzoic with other sweeteners. US Patent Publication No. 20060093720 teaches the use of a polyol in combination with a high intensity sweetener. US Patent Publication No. 20100009052 teaches the use of a high intensity sweetener together with nitrous oxide in an amount to reduce the aftertaste of the high intensity sweetener. US 20100298242 teaches a method of masking the taste of compositions containing salt. US Patent Publication 20090011108 teaches derivatives of glycyrrhizinate including glycyrrhizic acid, monoammonium glycyrrhizinate, diammonium glycyrrhizinate, dipotassium glycyrrhizinate, disodium glycyrrhizinate, triammonium glycyrrhizinate and is incorporated herein in its entirety. US Patent Publication 20100298242 teaches that masking of the salty taste of ORS solutions is not possible by the addition of an individual sweetener.

Prior art attempts to address the problem have resulted in a multitude of low calorie rehydration beverages or sport drinks, which nevertheless use glucose to salt ratios of 5 to 1 or greater. Even with current analytical equipment and techniques, scientists and technicians of the international food and beverage companies have failed to solve the long standing problem of developing a rehydration beverage which has an acceptable taste and utilizes glucose to salt ratios of 3 to 1 or less due to the inability of finding an acceptable sugar substitute which effectively mask the taste of the salt in the electrolytes at a sufficient level to minimize the calories of the sweetener.

Accordingly, there remains a need in the art for an oral rehydration solution which satisfactorily addresses the problem of acceptable taste and more closely models the World Health Organization's formula for an appropriate ORS by maintaining an equimolar concentration of sodium and glucose.

### SUMMARY

The presently-disclosed subject matter meets some or all of the above-identified needs, as will become evident to those of ordinary skill in the art after a study of information provided in this document.

This Summary describes several embodiments of the presently-disclosed subject matter, and in many cases lists variations and permutations of these embodiments. This Summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently-disclosed subject matter, whether listed in this Summary or not. To avoid excessive repetition, this Summary does not list or suggest all possible combinations of such features.

A principal object of the present invention is to provide a pleasant-tasting oral rehydration composition while maintaining a glucose to sodium ratio of about 1:1. In order to maintain this balance there isn't much room to independently alter the quantities of critical ingredients. This makes the challenge of masking the salty taste of this formulation very difficult. Without the addition of the licorice/licorice derivatives as used in the presently-disclosed subject matter, it would take enormous amounts of high intensity sweeteners to mask the salty taste of the oral rehydration composition. However, there are limits on the amount of high intensity sweetener that can be used due to the restricted acceptable daily intake, (“ADI”), set forth by the US Food and Drug Administration. In addition, the high intensity sweeteners have an after taste which becomes prominent with increased quantity.

Licorice and licorice derivatives are extremely effective in masking the aftertaste from high intensity sweeteners while producing a more uniform sweetness profile. They also help in eliminating the irregularities in sweetness and extending the sweetness. The licorice and licorice derivatives utilized in the present invention can also synergize with high intensity sweeteners, when they are used in the formulation, to deliver comparable sweetness at reduced overall dosages, leading to both economic benefits and performance benefits.

The formulation provides a composition with an acceptable taste without compromising the equimolar concentration of sodium and glucose, using a licorice based flavor enhancer and an optional high intensity sweetener(s). Prior to the development of the instant rehydration composition, power drinks and rehydration beverages typically contained up to about 5 times as much glucose as salts and depended upon using high levels of high intensity sweeteners together with conventional glucose based sweeteners to minimize calories and reintroduce electrolytes into the user's body.

The presently-disclosed subject matter is directed to oral rehydration compositions utilizing licorice or a licorice derivative. In some embodiments, the oral rehydration composition comprises a glucose-containing saccharide at a level less than about 63.95% w/w, sodium at a level greater than or equal to about 8.02% w/w, chloride at a level greater than or equal to about 8.96% w/w, and licorice or a licorice derivative.

In other embodiments, the oral rehydration composition is provided as a packaged beverage comprising water and an oral rehydration composition comprising a glucose-containing saccharide at a level less than about 63.95% w/w, sodium at a level greater than or equal to about 8.02% w/w, chloride at a level greater than or equal to about 8.96% w/w, and licorice or a licorice derivative. In some embodiments, the water is provided at a percentage of about 95 to about 99.25 wt % of the beverage.

In some embodiments, the glucose-containing saccharide is dextrose. In some embodiments, the dextrose is anhydrous.

In some embodiments, the composition further comprises potassium. In some embodiments, potassium is provided at a level less than about 5% w/w.

In some embodiments, the licorice derivative is mono-ammonium glycyrrhizinate. In some embodiments, the licorice or licorice derivative is provided at a level of about 0.0001 to about 0.5% w/w.

In some embodiments, the total carbohydrates in the composition are less than about 63.95% w/w.

In some embodiments, the composition further comprises sodium citrate and/or citric acid. In some embodiments, the sum of the citrate and citric acid is at a level between about 10 and 25% w/w.

In some embodiments, the composition further comprises a high intensity sweetener. In some embodiments, the high intensity sweetener is selected from the group consisting of: saccharin, aspartame, acesulfame potassium compounds, sucralose, neotame, advantame, steviol glycosides, Luo Han Guo fruit extracts, alitame, cyclamate, thaumatin, and dihydrochalcones. In some embodiments, the high intensity sweetener is sucralose. In some embodiments, when the high intensity sweetener is sucralose, the sucralose is provided at a level of less than about 0.5% w/w.

In some embodiments, the composition has a pH of between about 3.5 and 7.5. In some embodiments, the composition has a pH of at least about 5.0.

In some embodiments the composition further comprises one or more flavor compounds. In some embodiments, the one or more flavor compounds are at a level of between about 0.1% to about 0.9% w/w. In some embodiments, the flavor compound is orange, lemon-lime, apple and/or berry.

In some embodiments, the oral rehydration composition has a sodium content at least in equimolar concentration to the glucose-containing saccharide. In some embodiments, the sodium and glucose are in equimolar concentration.

In some embodiments, the oral rehydration composition is mixed with an effective amount of water. In some embodiments, the oral rehydration composition is mixed with water to provide a beverage; in some embodiments the water comprises from about 95 to about 99.25 wt % of the beverage. In some embodiments, upon mixture with an effective amount of water, the composition has an osmolarity of between 246 mOsm/L and 311 mOsm/L.

In some embodiments, the composition comprises dextrose at a level of about 50-65% w/w, sodium chloride at a level of about 10-15% w/w, potassium chloride at a level of about 5-10% w/w, sodium citrate at a level of about 10-15% w/w, citric acid at a level of about 1-3% w/w, and mono-ammonium glycyrrhizinate at a level of about 0.01 to 0.1% w/w. In some embodiments, the composition further comprises sucralose at a level of about 0.25 to 0.5% w/w and/or a flavor compound, wherein the total flavor compounds is about 0.1% to 0.9% w/w.

In some embodiments, the composition is provided as a ready-to-mix powdered formulation provided for combination with 1 L of water, comprising: about 10 to 15 g dextrose, about 1.5 to 2.5 g sodium citrate, about 2 to 4 g sodium chloride, about 1 to 2 g potassium chloride, about 0.25-0.50 g citric acid, and about 0.001 to 0.1 g licorice and/or a licorice derivative. In some embodiments, the ready-to-mix powdered formulation optionally includes a high intensity sweetener. In some embodiments, the high intensity sweetener can be sucralose.

The presently-disclosed subject matter also provides a method of making an oral rehydration solution, comprising: combining water and an oral rehydration composition comprising a glucose-containing saccharide at a level less than about 63.95% w/w, sodium at a level greater than or equal to about 8.02% w/w, chloride at a level greater than or equal to about 8.96% w/w, and licorice or a licorice derivative.

The presently-disclosed subject matter also provides a method of treating dehydration, comprising: administering to a subject an oral rehydration solution comprising water and an oral rehydration composition comprising a glucose-containing saccharide at a level less than about 63.95% w/w, sodium at a level greater than or equal to about 8.02% w/w, chloride at a level greater than or equal to about 8.96% w/w, and licorice or a licorice derivative.

Further features and advantages of the present invention will become evident to those of ordinary skill in the art after a study of the description, figures, and non-limiting examples in this document.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are used, and the accompanying drawings of which:

FIG. 1 is a graph depicting a comparison of the relative intensity and sweetness onset of various sweeteners and the flavorant/sweetener monoammonium glycyrrhizinate; and

FIG. 2 is a graph depicting the reduction in salty taste of oral compositions when monoammonium glycyrrhizinate “MAG” is used in addition to the high intensity sweetener SUCRALOSE.

### DESCRIPTION OF EXEMPLARY EMBODIMENTS

The presently-disclosed composition has a pleasant and natural taste while providing a rehydration beverage that more-closely models the World Health Organization's formula for an appropriate ORS. The composition contains a flavorant/sweetener such as a mono-ammonium glycyrrhizinate (“MAG”), optionally in combination with a FDA-approved high intensity sweetener that provides a less intense sweetness initially, building in intensity over time to extend the sweetness profile and help abate or eliminate the customary salty taste of the rehydration solution. Providing a rehydration composition containing approximately equimolar amounts of glucose and sodium that masks the salty taste was achieved by the balanced formulation disclosed herein. Prior to the development of the instant rehydration composition, power drinks and rehydration beverages typically contained about 5 times as much glucose as salts and depended upon using high levels of high intensity sweeteners together with conventional glucose based sweeteners to minimize calories and reintroduce electrolytes into the users body.

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

Unless defined otherwise, all technical and scientific terms used herein have the same meaning as is commonly understood by one of skill in the art to which the invention(s) belong. All patents, patent applications, published applications and publications, databases, websites and other published materials referred to throughout the entire disclosure herein, unless noted otherwise, are incorporated by reference in their entirety. In the event that there is a plurality of definitions for terms herein, those in this section prevail. Where reference is made to a URL or other such identifier or address, it understood that such identifiers can change and particular information on the internet can come and go, but equivalent information can be found by searching the internet. Reference thereto evidences the availability and public dissemination of such information.

Although any methods, devices, and materials similar or equivalent to those described herein can be used in the practice or testing of the presently-disclosed subject matter, representative methods, devices, and materials are now described.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, “optional” or “optionally” means that the subsequently described event or circumstance does or does not occur and that the description includes instances where said event or circumstance occurs and instances where it does not.

The term “beverage” is defined as any drinkable liquid or semi-liquid, including flavored water, soft drinks, fruit drinks, coffee-based drinks, tea-based drinks, juice-based drinks, milk-based drinks, jelly drinks, carbonated or non-carbonated drinks, and alcoholic or non-alcoholic drinks.

The term “concentrate” or “beverage base” is defined as an intermediate beverage product which, when mixed with an appropriate amount of water or other suitable liquid or semi-liquid forms a beverage syrup or alternatively a beverage. The beverage concentrate generally comprises a flavoring agent and optional additives.

The term “beverage syrup” is defined as an intermediate beverage product prepared from a beverage concentrate such as a dry powder or granulated substance and an amount of water or other suitable liquid or semi-liquid that can be diluted to form a beverage. The beverage syrup generally includes at least one flavoring agent, and optionally includes non-material or nonessential optional additives such as food-grade acids, coloring agents, and the like.

The term “sweetener” includes caloric sweeteners, low calorie sweeteners and non-caloric sweeteners or combination thereof. The sweetening agent may be used in many distinct physical forms well-known in the art to provide a delayed and/or a prolonged sensation of flavor. Without being limited thereto, such physical forms include free forms, such as spray dried, powdered, beaded forms, encapsulated forms; and mixtures thereof.

Sugar sweeteners include caloric sweetener or nutritive sweetener refers to a sweetener that is metabolized in the body to produce energy, such as a sugar, which produces about 4 Kcal/g of energy. Such materials include monosaccharides, disaccharides, polysaccharides and mixtures thereof. Examples include, but are not limited to, xylose, ribose, glucose, lactose, mannose, galactose, fructose, dextrose, sucrose (sugar), maltose, dextrin, fructo-oligosaccharide syrups, partially hydrolyzed starch, corn syrup solids, glucose syrup solids, honey, maple sugar, brown sugar and mixtures thereof. Sugar refers to sucrose. Sugar can be derived from sugar cane, sugar beet, or from various other botanical sources, such as the sugar maple tree.

A non-caloric or non-nutritive sweetener is a molecule or compound that generally provides only sweetening, with only negligible if any energy in the body. This can be because the non-caloric or non-nutritive sweetener is not metabolized by the body, or because such a small amount of the material is used that it contributes little if any calories, and thus substantially less energy than a caloric sweetener providing equivalent sweetening. A high intensity sweetener refers to a sweetening agent that has about 30 times to about 13,000 times or more the sweetness of sugar. The intense sweetening agents may be used in many distinct physical forms well-known in the art to provide an initial burst of sweetness and/or a prolonged sensation of sweetness. High-intensity sweeteners are commonly used as sugar substitutes or sugar alternatives because they are many times sweeter than sugar but contribute only a few to no calories when added to foods. High-intensity sweeteners, like all other ingredients added to food in the United States, must be safe for consumption.

Any high intensity sweetener approved by the U.S. Food and Drug Administration may be used as a high intensity sweetener in the instant invention. The high intensity sweeteners approved as of the date of this application include saccharin, aspartame, acesulfame potassium (Ace-K) compound, sucralose, neotame, advantame, steviol glycosides, Luo Han Guo fruit extracts. Other high intensity sweeteners include alitame, cyclamate, thaumatin, and dihydrochalcones.

In some embodiments, the high intensity sweetener can be sucralose. Sucralose is sold under the brand name of SPLENDA®. It is 200 to 700 times sweeter than table sugar (sucrose). Sucralose, which is the compound 4,1′,6′-trichloro-4,1′,6′-trideoxysucrose, comprises sweeteners including chlorodeoxysugar derivatives such as derivatives of chlorodeoxysucrose or chlorodeoxygalactosucrose, known, for example, under the product designation of sucralose; examples of chlorodeoxysucrose and chlorodeoxygalactosucrose derivatives include but are not limited to: 1-chloro-1 1-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-l-chloro-l-deoxy-beta-D-fructo-furanoside, or 4, l′-dichloro-4,1′-dideoxygalactosucrose; 1′,6′-dichloro 11,61-dideoxy sucrose; 4-chloro-4-deoxy-alpha-D-galactopyranosyl-1,6-dichloro-1,6-dideoxy-beta-D- -fructofuranoside, or 4,1′,6′-trichloro-4,1′,6′-trideoxygalactosucrose; 4,6-dicialoro-4,6-dideoxy-alpha-D-galactopyranosyl-6-chloro-6-deoxy-beta-D-fructofuranoside, or 4,6,6′-trichloro-4,6,61-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro4,6,1′,6′-tetradeoxygalacto-sucrose; and 4,6,1′,6′-tetradeoxy-sucrose, and mixtures thereof.

In some embodiments, the high intensity sweetener can be Acesulfame potassium (Ace-K). In some embodiments, the high intensity sweetener can be a chlorinated derivative of sucrose such as chlorodeoxysucrose and the like.

In some embodiments, the high intensity sweetener can be Neotame, which is sold under the brand name NEWTAME®, and is approximately 7,000 to 13,000 times sweeter than table sugar.

In some embodiments, the high intensity sweetener is advantame, a non-nutritive sweetener approximately 20,000 times a sweet as sucrose.

In some embodiments, saccharin or one of its salts is used as a high intensity sweetener. Saccharin and its salts, e.g. sodium or calcium saccharin salts, are about 200 to 700 times as sweet as table sugar. Saccharin is sold under the trade name of NUTRASWEET, EQUAL, and SUGAR TWINS. Saccharin contains calories, but less than sugar. In other embodiments, steviol glycosides can be used. Steviol glycosides such as Stevioside and rebaudioside are natural constituents of the leaves of Stevia rebaudiana, a plant native to parts of South America commonly known as Stevia and are 200 to 400 times sweeter than sugar.

It is contemplated that Luo Han Guo fruit extracts can also be used in the present invention. Luo Han Guo fruit extracts contain varying levels of mogrosides, which are the non-nutritive constituents of the fruit primarily responsible for the characteristic sweetness of SGFE. SGFE, depending on the mogroside content, is reported to be 100 to 250 times sweeter than sugar. Siraitia grosvenorii (Swingle) commonly known as Luo Han Guo or monk fruit is a plant native to Southern China.

Other high intensity sweeteners that can be used in the present invention include L-alpha-aspartyl-N-(2,2,4,4-tetramethyl-3-thietanyl)-D-alaniriamide hydrate (alitame) and equivalents; cyclamate and its salts; maltol, which is 3-hydroxy-2-methyl-4-pyrone; ethyl maltol; the dihydrochalcones, such as neohesperidine dihydrochalcone; and protein based sweeteners, such as thaumatin (talin). Additional high intensity sweeteners that can be utilized in the present invention are set forth in U.S. Pat. No. 7,851,006, which is incorporated by reference herein.

The sweetener may be added in a free form such as a spray dried form, a powdered form, a beaded form, an encapsulated form, gel block, squirt bottle, and mixtures thereof.

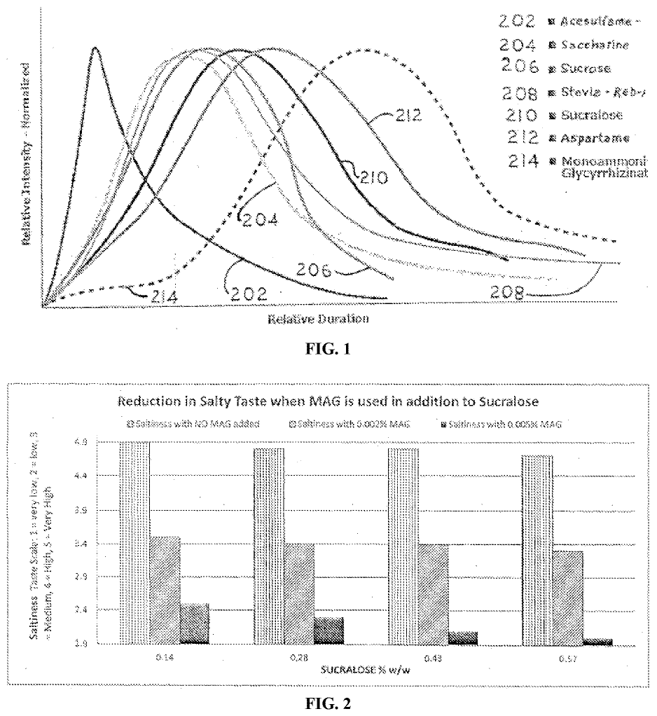

FIG. 1 shows the relative intensity of selected high intensity sweeteners with respect to relative duration of taste. It is contemplated that combinations of high intensity sweeteners can be included, making use of the sweetening power, duration, and carbohydrate content, if any, as a guide in selecting the relative amounts for the present formula.

The terms “licorice” and “licorice derivative” include licorice, derivatives of licorice, such as, for example, mono-ammonium glycyrrhizinate or other glycyrrhizinates, water soluble glycyrrhizin compounds and other licorice extracts. Examples of licorice derivatives include glycyrrhizic acid (or glycyrrhizin or glycyrrhizinic acid), 18 Beta glycyrrhizic acid, ammoniated glycyrrhizin, monoammonium glycyrrhizinate, diammonium glycyrrhizinate, dipotassium glycyrrhizinate, disodium glycyrrhizinate, trisodium glycyrrhizinate, triammonium glycyrrhizinate, and stearyl glycyrrhetinate.

Glycyrrhizin is a triterpene glycoside with the systematic name (3-beta,20-beta.)-20-carboxy-11-oxo-30-norolean-12-en-3-yl-2-0-beta-D-glucopyranuronosyl-alpha-D-glucopyranosiduronic acid. Glycyrrhizin is the active principle of licorice root, and has been used for numerous medical purposes, particularly treatment of peptic ulcer, and as an expectorant. Glycyrrhizin is about 50 to 100 times sweeter than sucrose, and also has a strong licorice note. Glycyrrhizin is used as a flavor modifier because of its ability to mask bitterness. For example, the addition of glycyrrhizin to an extract of coffee eliminates the coffee's bitter taste. Monoammonium glycyrrhizinate (“MAG”) is a derivative of glycyrrhizin and the extraction/purification process used for its production removes the residual licorice taste, leaving a flavorant/sweetener that is intensely sweet but otherwise unflavored. Glycyrrhizin potentiates sweetness, masks chemical off-notes, reduces harsh and bitter notes, and enhances other flavors.

As shown in FIG. 1, the sweetness onset of various sweeteners is compared to the flavorant/sweetener monoammonium glycyrrhizinate wherein the graph compares the relative intensity to the relative duration of the sweetener as reported at www.magnasweet.com/en/32/sweetness-onset.html as set forth in September of 2014. The delayed onset and extended sweetness of monoammonium glycyrrhizinate is useful for extending the flavor delivery for a longer time as compared with other conventional and high intensity sweeteners for its sweetness intensity peaks after the other sweeteners.

Additional flavorants and/or flavors are contemplated for use in the present invention.

As set forth in U.S. Pat. No. 7,851,006, hereby incorporated by reference, compounds that provide flavor (flavorings or flavor agents) include natural and artificial flavors. These flavorings can be chosen from synthetic flavor oils and flavoring aromatics and/or oils, oleoresins and extracts derived from plants, leaves, flowers, fruits, and combinations thereof.

Flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya can also be used. Additional flavors include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, ail ajowan flavor, an anise flavor, an angelica flavor, a fennel flavor, an allspice flavor, a cinnamon flavor, a camomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. Commonly used flavors include mints such as peppermint, menthol, spearmint, artificial vanilla, cinnamon derivatives, and various fruit flavors, whether employed individually or in admixture. Flavors can also provide breath freshening properties, particularly the mint flavors when used in combination with cooling agents.

Other useful flavorings include aldehydes and esters such as cimaamyl acetate, cinnamaldehyde, citral diethylacetal, dihydrocarvyl acetate, eugenyl formate, and p-methylamisol. Any flavoring or food additive such as those described in Chemicals Used in Food Processing, publication 1274, pages 63-258, by the National Academy of Sciences, which is incorporated herein by reference, can be used.

Moreover, aldehyde flavorings include acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronella) (modifies, many types), decanaf (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimetlayloctanal (green fruit), and 2-dodecenal (citrus, mandarin), cherry, grape, strawberry shortcake, and mixtures thereof.

The flavor agent can be employed in either liquid form and/or dried form, alone or in combination. Suitable drying means such as spray drying the oil can be used or the flavor agent can be absorbed onto water soluble materials, such as cellulose, starch, sugar, maltodextrin, gum arabic and so forth or can be encapsulated.

It is contemplated that the licorice and licorice derivatives described as flavorant/sweeteners in the instant composition can be used to lower the levels of conventional sweeteners with optional high intensity sweeteners to provide a composition exhibiting a glucose to sodium ratio of 5:1 or less, 4:1 or less, more preferably a with a glucose to sodium ratio of 3:1 or less, 2:1 or less, and most preferably in a glucose to sodium ratio of 1:1. Thus, the present invention can be used to provide low calorie drinks and sports beverages which exhibit a more pleasant flavor and still achieve a glucose to sodium level which is less than that of conventional sports drinks and rehydration formulations. Table 1 shows a comparison of the glucose and sodium present in PEDIALYTE®, a commercially available oral rehydration beverage, GATORADE® sports drink, and a composition according to the presently-disclosed subject matter, labeled as NORMALYTE®. As evidenced in the Table 1, the present oral rehydration formula maintains the quantitative ratio of dextrose and sodium. The quantities of dextrose, sodium chloride and sodium citrate maintained relative to each other achieve a sodium and glucose molecular balance.

TABLE 1

| | | | | | Osmolality | | | |
|---|---|---|---|---|---|---|---|---|
| Electrolyte | Carbohydrate | | Sodium | Potassium | (mOsm/Kg | Calories | | Price |
| Drink | (gm/L) | Type | (mEq/L) | (mEq/L) | H20) | (kcal/L) | pH | ($/L) |
| NormaLyte ® | 13.5 | Glucose | 75 | 20 | 252 | 55 | 5.4 | 2.66 |
| PediaLyte ® | 23 | Glucose | 43 | 19 | 270 | 90 | 3.6 | 4.65 |
| Powder Packs | | | | | | | | |
| | High | | Low on | | Higher | Higher | Highly | Expensive |
| | on | | Sodium | | Osmolarity | Calories | Acidic | |
| | Carbs | | | | | | | |
| Gatorade ® | 58 | Sucrose | 20 | 3 | 355 | 211 | 3.0 | 1.00 |
| (Sports | | Fructose | | | | | | |
| Drink) | | Glucose | | | | | | |
| | Very | Disaccharides | Very | Very Low | Very High | Too many | Highly | |
| | High | reduce and | Low on | on | Osmolarity | calories | Acidic | |
| | on | delay the | Sodium | Potassium | | | | |
| | Carbs | absorption of | | | | | | |
| | | Sodium | | | | | | |

When combined with a selected amount of a flavorant/sweetener and an optional high intensity sweetener(s), the oral rehydration composition of the present invention utilize a sugar sweetener such as dextrose anhydrous, a purified D-Glucose not containing crystallization water, in an effective amount of between 0.5 to 6.0% by weight in one liter of water, more preferably from 1 to 4% by weight in one liter of water, and more preferably from 1 to 2% by weight in one liter of water. One preferred embodiment as set forth in Table 1 utilizes anhydrous Dextrose in a range of from 0.5000 to 6.0000% by weight and. more preferably 1.350% by weight when used in accordance with the formulation set forth in Table 1. In some embodiments, the oral rehydration composition includes a sugar sweetener in an amount of about 0.5, 1.0, 1.5, 2.0, 2.5, 3.0, 3.5, 4.0, 4.5, 5.0, 5.5, or 6.0% by weight in one liter of water. In some embodiments, the oral rehydration composition includes a sugar sweetener in an amount of about 1.10, 1.15, 1.20, 1.25, 1.30, 1.35, 1.40, 1.45, 1.50, 1.55, 1.60, 1.65, 1.70, 1.75, 1.80, 1.85, 1.90, 1.95, or 2.00% by weight in one liter of water.

One embodiment of the present composition includes a high intensity sweetener, such as Sucralose, in an amount ranging from about 0.0001% to about 0.1% by weight of the diluted composition in one liter of water more specifically about 0.001% to about 0.050% by weight in one liter of water, and in other embodiments in amounts of about 0.01% to about 0.015% by weight of the diluted composition in one liter of water, and can be used in accordance with the formulation set forth in Table 1. In some embodiments, the oral rehydration composition includes a high intensity sweetener in an amount of about 0.0001, 0.0005, 0.0010, 0.0015, 0.0020, 0.0025, 0.0030, 0.0035, 0.0040, 0.0045, 0.0050, 0.0055, 0.0060, 0.0065, 0.0070, 0.0075, 0.0080, 0.0085, 0.0090, 0.0095, 0.010, 0.015, 0.020, 0.025, 0.030, 0.035, 0.040, 0.045, 0.050, 0.055, 0.060, 0.065, 0.070, 0.075, 0.080, 0.085, 0.090, 0.095, 0.100% by weight in one liter of water.

In some embodiments, when combined with a selected amount of a sugar sweetener, and a selected high intensity sweetener such as sucralose, the a flavorant/sweetener(s) for example mono-ammonium glycyrrhizinate compound, MAG, (designated as natural flavor) can be present in an effective amount of about 0.0001% to about 0.5% by weight when diluted with one liter of water, more preferably from 0.0005% to 0.1% by weight when diluted with one liter of water, and more preferably from 0.001% to 0.150% by weight when diluted with one liter of water. One preferred embodiment of the composition as set forth in Table 3 contains 0.001% by weight of the MAG diluted in one liter of water when used in accordance with the formulation set forth in Table 1.

In some embodiments, the oral rehydration composition includes a licorice or licorice derivative in an amount of about 0.0001, 0.0005, 0.0010, 0.0015, 0.0020, 0.0025, 0.0030, 0.0035, 0.0040, 0.0045, 0.0050, 0.0055, 0.0060, 0.0065, 0.0070, 0.0075, 0.0080, 0.0085, 0.0090, 0.0095, 0.010, 0.015, 0.020, 0.025, 0.030, 0.035, 0.040, 0.045, 0.050, 0.055, 0.060, 0.065, 0.070, 0.075, 0.080, 0.085, 0.090, 0.095, 0.100% by weight in one liter of water.

In some embodiments of the present invention contains up to 0.30% by weight of potassium chloride and in some instances, 0.150% by weight of potassium chloride, when used in accordance with the formulation set forth in Table 1. In some embodiments, the oral rehydration composition includes about 0.1, 0.15, 0.2, 0.25, or 0.3% by weight of potassium chloride.

The preferred embodiment of the present invention also contains sodium chloride in a range from about 0.0963 to 1.1556% by weight and in some instances contains 0.260% by weight of sodium chloride when used in accordance with the formulation set forth in Table 1. In some embodiments, the oral rehydration composition includes sodium chloride in an amount of about 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.10, 0.20, 0.30, 0.40, 0.50, 0.60, 0.70, 0.80, 0.90, 1.0, 1.1, 1.2, 1.3, 1.4, 1.5, or 1.6% by weight.

In some embodiments, the present invention contains citric acid in an amount up to 0.500% by weight, and, in some instances, 0.040% by weight of citric acid, when used in accordance with the formulation in Table 1. In some embodiments, the oral rehydration composition includes citric acid in an amount up to about 0.5, 0.4, 0.3, 0.2, 0.1, 0.09, 0.08, 0.07, 0.06, 0.05, 0.04, or 0.03% by weight.

In some embodiments of the present invention, sodium citrate is included in an amount ranging from 0.1074 to 1.2889% by weight and more preferably contains 0.290% by weight of sodium citrate (anhydrous) when used in accordance with the formulation in Table 1. In some embodiments, the oral rehydration composition includes sodium citrate in an amount of about 0.1, 0.2, 0.3, 0.4, 0.5, 0.6, 0.7, 0.8, 0.9, 1.0, 1.1, 1.2, 1.3, 1.4, or 1.5% by weight.

In some embodiments, an effective amount of an oral care agent can be added to the oral rehydration composition. The term oral care agent includes surfactants, breath freshening agents, anti-microbial agents, antibacterial agents, anti-calculus agents, anti-plaque agents, oral malodor control agents, fluoride compounds, quaternary ammonium compounds, remineralization agents and combinations thereof.

Antibacterial agents can be, for example, chlorhexidine, alexidine, quaternary ammonium salts, benzethonium chloride, cetyl pyridinium chloride, 2,4,41-trichloro-2′-hydroxy-diphenyl ether (triclosan) and combinations thereof.

Examples of suitable fluoride compounds include sodium fluoride, sodium monofluorophosphate, stannous fluoride and combinations thereof.

Anti-calculus agents include pyrophosphates, triphosphates, polyphosphates, polyphosphonates, dialkali metal pyrophosphate salt, tetra alkali polyphosphate salt, tetrasodium pyrophosphate, tetrapotassium pyrophosphate, sodium tripolyphosphate and combinations thereof.

Anti-microbial agents include cetylpyridinium chloride, zinc compounds, copper compounds and combinations thereof.

Remineralization agents comprise casein phosphopeptide-amorphous calcium phosphate, casein phosphoprotein-calcium phosphate complex, casein phosphopeptide-stabilized calcium phosphate, and combinations thereof.

In some embodiments, an effective amount of a pharmaceutical agent can be incorporated in the oral rehydration composition. Examples of pharmaceutical agents include drugs or medicaments, breath fresheners, vitamins and other dietary supplements, minerals, caffeine, nicotine, fruit juices and the like, and mixtures thereof. Further examples of pharmaceutical agents can be included, for example, as set forth in U.S. Pat. No. 7,851,006, which is herein incorporated by reference.

Compounds that provide saltiness can include conventional salts, such as sodium chloride, calcium chloride, potassium chloride, sodium bicarbonate, and 1-lysine and combinations thereof.

In some embodiments, potassium chloride is a component of the composition. In some embodiments, the composition contains up to 10% by weight of potassium chloride, and in some embodiments the percent by weight of potassium chloride is at a level of about 5-10%. The percent by weight of potassium chloride can be used in accordance with the formulation set forth in Table 1. In some embodiments, the oral rehydration composition includes potassium chloride in an amount up to about 10, 9, 8, 7, 6, 5, 4, or 3% by weight.

In some embodiments of the present invention, sodium chloride is included as a salt in the composition. In some embodiments, sodium chloride is provided in a range from about 10 to 15% by weight. In some embodiments the composition contains about 0.0963 to 1.1556% by weight of sodium chloride, and in some embodiments, 0.260% by weight of sodium chloride when used in accordance with the formulation set forth in Table 1. In some embodiments, the oral rehydration composition includes about 15, 10, 5, 1, 0.5, or 0.1% by weight of sodium chloride.

In some embodiments, the composition includes pH adjusters. In some embodiments, such adjusters are buffering systems. In some embodiments, the buffering systems can also provide flavor enhancement to the composition and can be available as organic acids, acidic salts and alkaline salts which inhibit or promote reaction between the calcium ion source by controlling the solubility of the calcium ion source. Exemplary of suitable alkaline salts are sodium citrate, sodium acetate, and sodium ascorbate. A suitable acidic salt is sodium acid pyrophosphate. Suitable organic acids include citric acid, acetic acid, malic acid, fumaric acid, ascorbic acid, and the like which can also be used as flavoring agents. Exemplary of suitable buffering systems are sodium citrate and citric acid, sodium acetate and acetic acid, and sodium ascorbate and ascorbic acid. The amount of organic acid, acidic salt or buffering system optionally added is generally sufficient to provide a pH of between about or at 3.5 to about or at 7.5. In some embodiments, the pH is at least 5, in some embodiments, the pH is about 5.4. In some embodiments, the pH is about 3.5, 4.0, 4.5, 5.0, 5.5, 6.0, 6.5, 7.0, or 7.5.

If a pH adjuster is included in the formulation, the pH adjuster can be dissolved in an amount of water sufficient to form a solution prior to adding to the water of the composition. Alternatively, the pH adjuster can be provided in powdered form when the composition is provided as a stick packet or as a powder.

In some embodiments of the invention, citric acid is provided at a level of about 1 to 3% w/w. In some embodiments of the present invention, when used in accordance with the formulation containing one liter of water in Table 1, citric acid is provided in the composition in an amount up to 0.500% by weight and more preferably contains 0.040% by weight of citric acid. In some embodiments, the oral rehydration composition includes citric acid in an amount up to about 3, 2.5, 2, 1.5, 1, 0.5, 0.4, 0.3, 0.2, 0.1, 0.09, 0.08, 0.07, 0.06, 0.05, 0.04, or 0.03% by weight.

One embodiment of the present invention contains sodium citrate in an amount ranging from about 0.1074 to about 1.2889% by weight and more preferably contains 0.290% by weight of sodium citrate, anhydrous when used in accordance with the formulation containing water in Table 1. In some embodiments, the oral rehydration composition includes about 0.1, 0.2, 0.3, 0.4, 0.5, 0.6, 0.7, 0.8, 0.9, 1.0, 1.1, 1.2, 1.3, 1.4, or 1.5% by weight of sodium citrate, anhydrous when used in accordance with the formulation containing water. In some embodiments, sodium citrate is provided at a level of about 10, 11, 12, 13, 14, or 15% w/w before addition of water.

A principal object of the present invention is to provide a pleasant tasting oral rehydration composition and maintain a glucose to sodium ratio of about 1:1. It is an object of the present invention to avoid the fluid loss due to osmotic effect. In one embodiment, the solution contains one mole of glucose for every one mole of sodium in order to maintain an equal sodium and glucose molecular balance and increase the efficiency of adsorption of sodium without making the solution hyper-osmolar. The osmolarity of the present compositions provide a range between about 246 and 311 mOsm/L. In some embodiments, the osmolarity of the composition is about 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, or 311 mOsm/L.

It is anticipated that the present composition can take many forms. In some embodiments, the oral composition is provided as a beverage. Some embodiments of the rehydration compositions can contain a portion of added water. The added water can be specifically purified prior to use using processes well-known in the art such as filtration, deionization, distillation, or reverse osmosis. “Added water” does not include water incidentally added to the composition through other components such as milk or a fruit juice component.

Based upon the total weight of the composition, upon dilution the beverage composition can contain up to 99.9% water, more preferably from 90% (wt %) to 99.9% by weight water, more preferably from about 95 to 99.25 wt % more preferably from about 97 to about 99 wt %, water based on the total weight of the composition. As set forth in Table 3, one preferred composition contains about 98 wt % water. In some embodiments, based on the total weight of the composition, upon dilution the beverage composition can contain about 90, 91, 92, 93, 94, 95, 96, 97, 98, or 99 wt % water.

In some embodiments, the oral rehydration composition can be utilized as a carbonated beverage in the form of a fountain beverage wherein the syrup is carbonated upon serving, or as a prebottled or canned beverage. An effective amount of carbon dioxide or carbonated water can be added to the oral rehydration composition to provide a refreshing beverage.

Beverages suitable for use in the present invention comprise soft or carbonated drinks, juice-based drinks, milk-based drinks, chocolate milk, beverages made from brewed components such as teas and coffees, beverage mixes, beverage concentrates, powdered beverages, beverage syrups, frozen beverages, gel beverages, alcoholic beverages, and the like. It is contemplated that a concentrate can be administered in gel form, dissolvable tablet form, a “chewy block” form without water, a pre-made solution made for dilution in specific quantities such as one liter, and even a “concentrate syrup”. Other forms contemplated for use include, but are not limited to, capsules, tablets, soft gels, liquid-filled capsules, effervescent tablets and powders, straws containing a powdered or encapsulated composition, and chewables.

In some embodiments for an oral rehydration composition, a ready-to-mix powdered formulation to replenish the electrolytes lost due to dehydration is provided. The compositions can address dehydration caused by diarrhea, vomiting, excessive sweating, malnutrition, electrolyte disturbances, and other causes resulting in dehydration.

One non-limiting example of a powdered formulation that can be provided in stick packet form can contain approximately equimolar amounts of glucose to sodium having 13.5 grams of dextrose Anhydrous, 2.9 grams of sodium citrate, 2.6 grams of sodium chloride, 1.5 grams of potassium chloride, 0.4 grams of citric acid, and less than 1% of SUCRALOSE (typically 0.09 grams of sucralose NF), 0.11 grams of orange flavor, and 0.010 grams of a natural licorice based flavorant/sweetener comprising a glycyrrhizinate compound such as MAG.

The composition provides an effective amount of a mono-ammonium glycyrrhizinate flavorant/sweetener compound along with ingredients necessary to achieve a sodium and glucose molecular balance including one mole of glucose for every one mole of sodium. The powder in the packet can be conveniently transported and subsequently added to one liter of water. When dissolved in one liter of water, the composition contains about 74.1 mEq of sodium, about 20.1 mEq of potassium, about 64.6 mEq of chloride, about 74.9 mEq of anhydrous dextrose; about 29.6 mEq of citrate, and about 55 calories.

The presently-disclosed subject matter is further illustrated by the following specific but non-limiting examples. The following examples may include compilations of data that are representative of data gathered at various times during the course of development and experimentation related to the present invention.

### EXAMPLES

### Example 1

Example 1 provides a formulation with high intensity sweeter, natural flavorant/sweetener MAG and Orange flavor, along with the % by weight of each ingredient in a one liter beverage composition. The listed ingredients can be provided without water as a ready-to-mix powdered formulation.

| Dextrose Anhydrous USP | 13.5 | g | 1.32% | by wt |
|---|---|---|---|---|
| (sweetener) | | | | |
| Sodium Citrate USP | 2.9 | g | 0.28% | by wt |
| (buffer) | | | | |
| Sodium Chloride USP (salt) | 2.6 | g | 0.25% | by wt. |
| Potassium Chloride | 1.5 | g | 0.15% | by wt. |
| USP (salt) | | | | |
| Citric Acid SUP (flavorant) | 0.4 | g | 0.04% | by wt. |
| Sucralose NF (high intensity | 0.09 | g | 0.01% | by wt. |
| [symbol] | | | | |
| Orange Flavor | 0.110 | g | 0.01% | by wt. |
| Natural Flavor flavorant/ | 0.010 | g | 0.001% | by wt. |
| sweetener MAG | | | | |
| (Mono-ammonium | 21.8 g per satchet | | | |
| glycyrrhizinate) | | | | |
| Diluted in 1 liter of water. | 1000 | g | 97.93% | by wt |

[symbol]

indicates data missing or illegible when filed

TABLE 2

| | Maximum Limit | | | | | | |
|---|---|---|---|---|---|---|---|
| | (% content of | Existing Formula | | Range in Grams | | Range in % | |
| Ingredient | Food as served) | in Grams | in % | from | to | from | to |
| Dextrose, anhydrous | No Limit | 13.5 | 1 350 | 5.000 | 60.000 | 0.5000 | 6.0000 |
| Sodium Citrate, anhydrous | No Limit | 2.9 | 0.293 | 1.074 | 212.889 | 0.1074 | 1.2859 |
| Sodium Chloride | No Limit | 2.6 | 0.260 | 0.953 | 11.556 | 0.0963 | 1.1556 |
| Potassium Chloride | No Limit | 1.5 | 0.130 | 0.000 | 3.000 | 0.0000 | 0.3000 |
| Citric Acid | No Limit | 0.4 | 0.043 | 0.000 | 5.000 | 0.0000 | 0.5000 |
| Orange Flavor | No Limit | 0.09 | 0.009 | 0.000 | 1.000 | 0.0000 | 0.1000 |
| Sucralose | * | 0.11 | 0.011 | 0.001 | 0.150 | 0.0001 | 0.0150 |
| Licorice and Licorice | 0.15 | 0.01 | 0.001 | 0.001 | 1.500 | 0.0001 | 0.1500 |
| derivatives | | | | | | | |
| Drinking Water | No Limit | 1000 | 97.93% | | | | |

* Acceptable Daily Intake of Sucralose is limited to 15 mg/Kg of Body Weight per Day for the entire life of a human being.

Table 2 shows the glucose and salt ingredients in substantial sodium and glucose molecular balance. Utilizing the formula set forth in Example 1, Table 2 shows the dextrose to sodium equivalence beverage containing about one mole of glucose for every one mole of sodium in order to maintain an equal sodium and glucose molecular balance.

As provided in Table 3, the quantities of dextrose, sodium chloride, and sodium citrate should be maintained relative to each other. Table 3 shows the millimoles-per-liter of anhydrous dextrose (74.9) is balanced when compared to the total amount of sodium (44.47 millimoles/liter in sodium chloride) and (29.58 millimoles/liter in sodium citrate). The formulation provides equimolar concentrations of dextrose and sodium, exemplified in Table 3.

TABLE 3

| | | Molecular | | | | |
|---|---|---|---|---|---|---|
| | Qty | Mass | mmol/ | | | Mmoles/ |
| Ingredient | (Grams) | Grams/Mole | Gram | Molecule | Mass % | Liter |
| Dextrose, anhydrous | 13.50 | 180.16 | 5.5505 | Glucose | 100.00 | 74.93 |
| Sodium Chloride | 2.60 | 58.44 | 17.11 | Sodium | 39.34 | 44.49 |
| | | | | Chloride | 60.67 | 44.49 |
| Potassium Chloride | 1.50 | 74.55 | 13.41 | Potassium | 52.45 | 20.12 |
| | | | | Chloride | 47.56 | 20.12 |
| Sodium Citrate, anhydrous | 2.90 | 258.06 | 3.87 | Sodium | 26.73 | 33.71 |
| | | | | Citrate | 73.28 | 11.24 |
| Citric Acid | 0.40 | 192.12 | 5.21 | Citric Acid | 100.00 | 2.08 |

### Example 2

Example 2 provides a formulation without the use of Sucralose and as a ready-to-mix powdered formulation intended for human consumption to replenish the electrolytes lost due to dehydration caused by diarrhea, vomiting, excessive sweating, etc.

| Dextrose Anhydrous USP | 13.500 | g | 1.32% | by wt |
|---|---|---|---|---|
| (sweetener) | | | | |
| Sodium Citrate USP | 2.900 | g | 0.28% | by wt |
| (buffer) | | | | |
| Sodium Chloride USP (salt) | 2.600 | g | 0.25% | by wt. |
| Potassium Chloride | 1.500 | g | 0.15% | by wt. |
| USP (salt) | | | | |
| Citric Acid SUP (flavorant) | 0.400 | g | 0.04% | by wt. |
| Orange Flavor | 0.110 | g | 0.01% | by wt. |
| Natural flavor/ | 0.001-0.200 | g | 0.001-0.002% | by wt. |
| sweetener | | | | |
| (Mono-ammonium | 21.8 g per sachet | | | |
| glycyrrhizinate) | | | | |
| Diluted in 1 liter of water | 1000 | g | | |

TABLE 4

| | | | | | | | | | HNEL (Highest |
|---|---|---|---|---|---|---|---|---|---|
| | | | Molecular | | | | | | No Adverse |
| | | Qty | Mass | mmol/ | | | mmoles/ | | Effects |
| CAS # | Ingredient | (Grams) | Grams/Mole | Gram | Molecule | Mass % | Liter | Calories | Limit) |
| 50-99-7 | Dextrose, | 13.50 | 180.16 | 5.5506 | Glucose | 100.00 | 74.93 | 54 | |
| | anhydrous | | | | | | | | |
| | | | | | Sodium | 39.34 | 44.49 | | |
| 7647-14-5 | Sodium | 2.60 | 58.44 | 17.11 | Chloride | 60.67 | 44.49 | 0 | |
| | Chloride | | | | | | | | |
| 7447-40-7 | Potassium | 1.50 | 74.55 | 13.41 | Potassium | 52.45 | 20.12 | 0 | |
| | Chloride | | | | Chloride | 47.56 | 20.12 | | |
| 68-04-2 | Sodium | 2.90 | 258.07 | 3.87 | Sodium | 26.73 | 33.71 | 0 | |
| | Citrate, | | | | Citrate | 73.28 | 11.24 | | |
| | anhydrous | | | | | | | | |
| 77-92-9 | Citric Acid | 0.40 | 192.12 | 5.21 | Citric Acid | 100.00 | 2.08 | 1 | |
| 56038-13-2 | Sucralose | 0.09 | 397.64 | 2.51 | Sucralose | 100.00 | 0.23 | 0 | 1.5 Gm/Kg/day |
| | Orange | 0.11 | 136.24 | 7.34 | Orange | 100.00 | 0.23 | 0 | |
| | Flavor | | | | Flavor | | | | |

| | | | | | |
|---|---|---|---|---|---|
| 53956-04-0 | MAG Sweet | 0.01 | 0.00 | | Maybe |
| | | | | | 100 mg/Day |
| | Total | 21.11 | 252 | 55 | |

Table 4 shows a formulation, wherein a ready-to-mix powdered formulation is provided in a sachet weighing 21.11 grams and is diluted with one (1) liter of water. The flavorant/sweetener is a licorice or licorice derivative in an amount of 0.001% and constitutes a “natural flavor” designation by the US Food and Drug Administration. The composition provided in Table 4 provides a sodium and glucose molecular balanced ratio in a complete formula with effective amounts of specific sweeteners required to mask the salty taste of the electrolytes and ranges for the constituents, taking into consideration the substantially equimolar concentrations of the dextrose and sodium.

TABLE 5

| | | | | Sodium | | | | | | |
|---|---|---|---|---|---|---|---|---|---|---|
| Ingredients | Dextrose, | Sodium | Potassium | Citrate, | | | | | | |
| (grams) | anhydrous | Chloride | Chloride | anhydrous | Citric Acid | Sucralose | Orange Flavor | MAG | Total | pH |
| Formula-1 | 13.5 | 2.6 | 1.5 | 2.9 | 0 | 0.09 | 0.055 | 0.0085 | 20.65 | 7.8 |
| Formula-2 | 13.5 | 2.6 | 1.5 | 2.9 | 0.2 | 0.09 | 0.055 | 0.0085 | 20.85 | 6.3 |
| Formula-3 | 13.5 | 2.6 | 1.5 | 2.9 | 0.4 | 0.09 | 0.055 | 0.0085 | 21.05 | 5.93 |
| Formula-4 | 13.5 | 2.6 | 1.5 | 2.9 | 0.2 | 0 | 0.055 | 0.0085 | 20.76 | 6.46 |
| Formula-5 | 13.5 | 2.6 | 1.5 | 2.9 | 0.2 | 0.045 | 0.055 | 0.0085 | 20.81 | 6.23 |
| Formula-6 | 13.5 | 2.6 | 1.5 | 2.9 | 0.2 | 0.09 | 0.055 | 0.0020 | 20.85 | 6.03 |
| Formula-7 | 13.5 | 2.6 | 1.5 | 2.9 | 0.2 | 0.09 | 0.055 | 0.0150 | 20.86 | 6.39 |
| Formula-8 | 13.5 | 2.6 | 1.5 | 2.9 | 0.2 | 0.09 | 0.11 | 0.0085 | 20.91 | 5.93 |
| Formula-9 | 13.5 | 2.6 | 1.5 | 2.9 | 0.2 | 0.09 | 0.165 | 0.0085 | 20.96 | 5.62 |
| Derived Formula | 13.5 | 2.6 | 1.5 | 2.9 | 0.4 | 0.09 | 0.11 | 0.01 | 21.1100 | 5.44 |
| from Taste Test | | | | | | | | | | |
| Percentage | 63.95% | 12.32% | 7.11% | 13.74% | 1.89% | 0.43% | 0.52% | 0.05% | 100.00% | |
| Contents g/L | 13.5 | 2.6 | 1.5 | 2.9 | 0.4 | 0.09 | 0.11 | 0.01 | 21.11 | 1000 |
| Percentage/L | 1.35% | 0.26% | 0.15% | 0.29% | 0.04% | 0.01% | 0.01% | 0.001% | 2.111% | 100.00 |
| Per Lot | 44.766 | 8.622 | 4.974 | 9.616 | 1.326 | 0.298 | 0.365 | 0.033 | 70.000 | Kg |
| Per 20 Ft | 269 | 52 | 30 | 58 | 8 | 2 | 2 | 0 | 6.000 | |
| container Load | | | | | | | | | | |

Table 5 shows nine formulations for the present invention in which the citric acid, sucralose, orange flavor, and MAG were varied, resulting in a variance of the pH. While the pH is not critical in improving the hydration efficiency itself, it is important to maintain a closer to neutral pH so it does not worsen the dehydration effects. The citrate corrects acidosis cause by dehydration. The optional use of citric acid to enhance taste should be in amounts that will not increase the acidity (pH) substantially. It is noted that a commercially available rehydration formulation sold under the trade name, PEDIALYTE®, has a pH of 3.61. One preferred composition of the present formulation is set forth as the “Derived Formula from Taste Test” wherein the percent of each ingredient is listed and the pH is noted as 5.44.

TABLE 6

| | Item Number | | |
|---|---|---|---|
| | NL001 | | |
| | ORS 3 Pk | | |
| Norma- Lyte ® | 1000 mL | | % w/v |
| Ingredients | Orange | % w/w | (Gm/L) |
| Dextrose, anhydrous | 13.500 | 63.95% | 1.350% |
| Sucrose | | | |
| Sodium Chloride | 2.600 | 12.32% | 0.260% |
| Potassium Chloride | 1.500 | 7.11% | 0.150% |
| Sodium Citrate, | 2.900 | 13.74% | 0.290% |
| dihydrate | | | |
| Citric Acid | 0.400 | 1.89% | 0.040% |
| MAG Sweet | 0.010 | 0.05% | 0.001% |
| Sucralose | 0.090 | 0.43% | 0.009% |
| Orange | 0.110 | 0.52% | 0.011% |
| Lemon/Lime | | | |
| Flavor (Berry/Apple) | | | |
| Total Weight (Gm) | 21.110 | 100.00% | 2.111% |

1 Liter (Serving Size) of Prepared Solution Provides:

| Sodium | 1.703 | 8.07% | 0.170% |
|---|---|---|---|
| Potassium | 0.787 | 3.73% | 0.079% |
| Chloride | 2.29 | 10.85% | 0.229% |
| Citrate + Citric Acid | 2.265 | 10.73% | 0.227% |
| | Item Number | | |
| | N002 | | |
| | ORS 6Pk | | |
| Norma- Lyte ® | 500 mL | | % w/v |
| Ingredients | Orange | % w/w | (Gm/L) |
| Dextrose, anhydrous | 6.750 | 63.95% | 1.350% |
| Sucrose | | | |
| Sodium Chloride | 1.300 | 12.32% | 0.260% |
| Potassium Chloride | 0.750 | 7.11% | 0.150% |
| Sodium Citrate, | 1.450 | 13.74% | 0.290% |
| dihydrate | | | |
| Citric Acid | 0.200 | 1.89% | 0.040% |
| MAG Sweet | 0.005 | 0.05% | 0.001% |
| Sucralose | 0.045 | 0.43% | 0.009% |
| Orange | 0.055 | 0.52% | 0.011% |
| Lemon/Lime | | | |
| Flavor (Berry/Apple) | | | |
| Total Weight (Gm) | 10.555 | 100.00% | 2.111% |

1 Liter (Serving Size) of Prepared Solution Provides:

| | | | |
|---|---|---|---|
| Sodium | 0.8515 | 8.07% | 0.170 |
| Potassium | 0.3935 | 3.73% | 0.079 |
| Chloride | 1.145 | 10.85% | 0.229 |
| Citrate + Citric Acid | 1.1325 | 10.73% | 0.227 |

| | Item Number | | |
|---|---|---|---|
| | NL003 | | |
| | ORS 6Pk | | |
| Norma- Lyte ® | 500 mL | | % w/v |
| Ingredients | Lemon/Lime | % w/w | (Gm/L) |
| Dextrose, anhydrous | 6.750 | 63.95% | 1.350% |
| Sucrose | | | |
| Sodium Chloride | 1.300 | 12.32% | 0.260% |
| Potassium Chloride | 0.750 | 7.11% | 0.150% |
| Sodium Citrate, | 1.450 | 13.74% | 0.290% |
| dihydrate | | | |
| Citric Acid | 0.200 | 1.89% | 0.040% |
| MAG Sweet | 0.005 | 0.05% | 0.001% |
| Sucralose | 0.045 | 0.43% | 0.009% |
| Orange | | | |
| Lemon/Lime | 0.055 | 0.52% | 0.011% |
| Flavor (Berry/Apple) | | | |
| Total Weight (Gm) | 10.555 | 100.00% | 2.111% |

1 Liter (Serving Size) of Prepared Solution Provides:

| | | | |
|---|---|---|---|
| Sodium | 0.8515 | 8.07% | 0.170% |
| Potassium | 0.3935 | 3.73% | 0.079% |
| Chloride | 1.145 | 10.85% | 0.229% |
| Citrate + Citric Acid | 1.1325 | 10.73% | 0.227% |

| | Item Number | | |
|---|---|---|---|
| | NL004 | | |
| | ORS 6Pk | | |
| Norma- Lyte ® | 500 mL | | % w/v |
| Ingredients | Flavor | % w/w | (Gm/L) |
| Dextrose, anhydrous | 6.750 | 63.95 | 1.350 |
| Sucrose | | | |
| Sodium Chloride | 1.300 | 12.32 | 0.260 |
| Potassium Chloride | 0.750 | 7.11 | 0.150 |
| Sodium Citrate, | 1.450 | 13.74 | 0.290 |
| dihydrate | | | |
| Citric Acid | 0.200 | 1.89 | 0.040 |
| MAG Sweet | 0.005 | 0.05 | 0.001 |
| Sucralose | 0.045 | 0.43 | 0.009 |
| Orange | | | |
| Lemon/Lime | | | |
| Flavor (Berry/Apple) | 0.055 | 0.52 | 0.011 |
| Total Weight (Gm) | 10.555 | 100.00% | 2.111% |

1 Liter (Serving Size) of Prepared Solution Provides:

| Sodium | 0.8515 | 8.07% | 0.170% |
|---|---|---|---|
| Potassium | 0.3935 | 3.73% | 0.079% |
| Chloride | 1.145 | 10.85% | 0.229% |
| Citrate+Citric Acid | 1.1325 | 10.73% | 0.227% |
| | Item Number | | |
| | NL005 | | |
| Norma- Lyte ® | Pure 6Pk | | % w/v |
| Ingredients | 500 ml | % w/w | (Gm/L) |
| Dextrose, anhydrous | 6.750 | 62.76% | 1.350 |
| Sucrose | | | |
| Sodium Chloride | 1.000 | 9.30 | 0.200 |
| Potassium Chloride | 0.750 | 6.97 | 0.150 |
| Sodium Citrate, | 2.000 | 18.60 | 0.400 |
| dihydrate | | | |
| Citric Acid | 0.250 | 2.32 | 0.050 |
| MAG Sweet | 0.005 | 0.05 | 0.001 |
| Sucralose | | | |
| Orange | | | |
| Lemon/Lime | | | |
| Flavor (Berry/Apple) | | | |
| Total Weight (Gm) | 10.755 | 100.00% | 2.151% |

1 Liter (Serving Size) of Prepared Solution Provides:

| Sodium | 0.8625 | 8.02% | 0.173% |
|---|---|---|---|
| Potassium | 0.3935 | 3.66% | 0.079% |
| Chloride | 0.9633 | 8.96% | 0.193% |
| Citrate + Citric Acid | 1.5359 | 14.28% | 0.307% |
| | Item Number | | |
| | NL006 | | |
| | Sweet 6Pk | | |
| Norma- Lyte ® | 500 mL | | % w/v |
| Ingredients | Flavor | % w/w | (Gm/L) |
| Dextrose, anhydrous | | | |
| Sucrose | 13.500 | 76.88 | 2.700 |
| Sodium Chloride | 1.000 | 5.69 | 0.200 |
| Potassium Chloride | 0.750 | 4.27 | 0.150 |
| Sodium Citrate, | 2.000 | 11.39 | 0.400 |
| dihydrate | | | |
| Citric Acid | 0.250 | 1.42 | 0.05 |
| MAG Sweet | 0.005 | 0.03 | 0.001 |
| Sucralose | | | |
| Orange | | | |
| Lemon/Lime | 0.055 | 0.31 | 0.011 |
| Flavor (Berry/Apple) | | | |
| Total Weight (Gm) | 17.560 | 100.00 | 3.512 |

1 Liter (Serving Size) of Prepared Solution Provides:

| | | | |
|---|---|---|---|
| Sodium | 0.8625 | 4.91% | 0.173 |
| Potassium | 0.3935 | 2.24% | 0.079 |
| Chloride | 0.9633 | 5.49 | 0.193 |
| Citrate + Citric Acid | 1.5359 | 8.75 | 0.307 |

Table 6 provides exemplary formulas for 500 mL and 1000 mL oral rehydration compositions. The formulas include sucralose and optional flavor.

All publications, patents, and patent applications mentioned in this specification are herein incorporated by reference to the same extent as if each individual publication, patent, or patent application was specifically and individually indicated to be incorporated by reference.

It will be understood that various details of the presently-disclosed subject matter can be changed without departing from the scope of the subject matter disclosed herein. Furthermore, the foregoing description is for the purpose of illustration only, and not for the purpose of limitation.

What is claimed is:

1. A method of rehydrating, comprising: administering to a subject an oral rehydration solution comprising:
a) a glucose-containing saccharide, at a level less than about 63.95% w/w;
b) sodium, at a level greater than or equal to about 8.02% w/w;
c) chloride, at a level greater than or equal to about 8.96% w/w; and
d) licorice or a licorice derivative.

2. The method of claim 1, wherein the oral rehydration solution further comprises water.

3. The method of claim 2, wherein the water is in an amount effective to result in an osmolarity of between 246 mOsm/L and 311 mOsm/L

4. The method of claim 1, wherein the glucose-containing saccharide is at a level between about 60% to less than about 63.95% w/w.

5. The method of claim 1, wherein the sodium is at a level of about 8.02% to about 15.0% w/w.

6. The method of claim 1, wherein the oral rehydration solution is a liquid or a powder.

7. The method of claim 1, wherein the oral rehydration solution further comprises sodium citrate at a level between about 10% and 20%.

8. The method of claim 1, wherein the oral rehydration solution further comprises potassium, at a level less than about 5% w/w.

9. The method of claim 1, wherein total carbohydrates are less than about 63.95% w/w.

10. The method of claim 1, wherein the licorice or licorice derivative is mono-ammonium glycyrrhizinate.

11. The method of claim 1, wherein the licorice or licorice derivative is at a level of about 0.0001 to about 0.5% w/w.

12. The method of claim 1, wherein the oral rehydration solution further comprises sodium citrate and citric acid.

13. The method of claim 12, wherein the sum of the citrate and citric acid is at a level between about 10 and 25%.

14. The method of claim 1, wherein the oral rehydration solution further comprises a high intensity sweetener.

15. The method of claim 14, wherein the high intensity sweetener is selected from the group consisting of: saccharin, aspartame, acesulfame potassium compounds, sucralose, neotame, advantame, steviol glycosides, Luo Han Guo fruit extracts, alitame, cyclamate, thaumatin, and dihydrochalcones.

16. The method of claim 14, wherein the high intensity sweetener is sucralose.

17. The method of claim 1, wherein the oral rehydration solution further comprises one or more flavor compounds.

18. The method of claim 17, wherein the one or more flavor compounds are at a level of between about 0.1% to about 0.9% w/w.

19. The method of claim 1, wherein the oral rehydration solution comprises sodium and glucose in equimolar concentration.

20. The method of claim 1, wherein the glucose containing saccharide is dextrose.
